(19) United States
(12) Patent Application Publication
(10) Pub. No.: US 2021/0319489 A1
(43) Pub. Date: Oct. 14, 2021

(54) SYSTEMS AND METHODS FOR DETERMINATION OF LAWN NUTRIENT AND TREATMENT REGIMEN BASED ON PUBLICLY AVAILABLE INFORMATION AND SPECIFIC TESTING DATA AND THE PERIODIC DELIVERY OF SUPPLIES FOR SAID LAWN NUTRIENT AND TREATMENT REGIMEN

(71) Applicants: Justin Coulter Lewis, Lafayette, CO (US); David Trent Lewis, Boulder, CO (US); Jesse Robert McClure, Longmont, CO (US)

(72) Inventors: Justin Coulter Lewis, Lafayette, CO (US); David Trent Lewis, Boulder, CO (US); Jesse Robert McClure, Longmont, CO (US)

(21) Appl. No.: 16/848,714

(22) Filed: Apr. 14, 2020

(51) Int. Cl. G06Q 30/06; G06Q 50/16; G06Q 10/06; G06Q 30/02; G06Q 30/00; G06F 16/9537; A01C 21/00; G06T 7/62

(52) U.S. Cl. CPC G06Q 30/0621; G06Q 50/163; G06Q 10/06313; G06Q 30/0633; G06Q 30/0203; G06T 2207/30181; G06F 16/9537; A01C 21/007; G06T 7/62; G06T 2207/10032; G06Q 30/018

(57) ABSTRACT

A method of determining a lawn treatment plan and delivering lawn treatments includes receiving at a user interface an address having a lawn. The method further includes determining an initial lawn size for the lawn based on the address. The method further includes receiving confirmation of the initial lawn size. The method further includes calculating a lawn treatment plan based on the initial lawn size. The method further includes providing the lawn treatment plan to a customer. The method further includes providing instruction for providing the lawn treatment plan to a fulfillment center. The method further includes delivering packetized lawn treatments according to the lawn treatment plan on a periodic basis to the customer for treatment of the lawn.

### BACKGROUND

At approximately 40,000,000 acres, lawns are roughly tied with wheat for the third largest crop in the United States. The need for the care of lawns is widespread and commonly mismanaged due to decentralized care based on homeowners or dwelling occupiers. In many scenarios, it is difficult to determine the amount of nutrients the lawn needs or the proper nutrient blend. Finally, it is typically not cost effective to have an analyst visit each property to determine the needed dosage and nutrient content nor the delivery schedule and amount of fertilizer. Therefore, it is desirable to provide a system that determines the proper schedule, composition, and delivery of fertilizer.

### BRIEF SUMMARY

In one embodiment, a system for determining a lawn treatment plan and delivering lawn treatments includes a lawn treatment plan engine, the lawn treatment plan engine configured to query a customer for an address having a lawn. The lawn treatment plan engine is further configured to receive the address; calculate an initial lawn size for the lawn based on the address; and receive a confirmation of the initial lawn size. The lawn treatment plan engine is further configured to calculate a lawn treatment plan based on the initial lawn size; provide the lawn treatment plan to a customer; and provide instruction for providing the lawn treatment plan to a fulfillment center for delivering packetized lawn treatments according to the lawn treatment plan on a periodic basis to the customer for treatment of the lawn. Alternatively, the lawn treatment plan engine is further configured to receive an order indication after providing the lawn treatment plan to the customer; calculate a revised lawn size based on satellite image analysis; and revise the lawn treatment plan according to the revised lawn size. In one alternative, the lawn treatment plan engine is further configured to cause a fulfillment center to deliver a soil test to the customer for sampling of soil from the lawn; receive soil composition based on the customer delivering the soil test to a lab and the lab determining the soil composition; and revise the lawn treatment plan according to the soil composition. In another alternative, the lawn treatment plan engine is further configured to receive from the consumer, answers to a questionnaire; revise the lawn treatment plan according to the answers. Alternatively, the lawn treatment plan engine is further configured to as part of the determination of the lawn treatment plan to determine an amount of a required nutrient for a period of time by the lawn; and determine what packets of a plurality of possible packets to deliver to meet the amount, wherein the plurality of possible packets are provided in preset configurations of sizes and nutrient contents. In another alternative, the packets are selected based on the soil composition, current year weather, forecast weather, and the answers to the questionnaire. Alternatively, the soil composition is initially based on location of the address. In another alternative, the growth potential for the lawn is determined for the selection of the packets. Alternatively, the lawn treatment plan is adjusted according to changes in long term weather forecasts. In another alternative, the lawn treatment plan is adjusted according to recent weather trends. Alternatively, the lawn treatment plan is adjusted according to a change in known characteristics of the lawn. In one alternative, the lawn treatment plan is adjusted according to a change in characteristics of the lawn. In another alternative, the lawn treatment plan is adjusted according to a change in environmental characteristics of the lawn. Alternatively, the lawn treatment plan is adjusted according to the customer compliance with the lawn treatment plan.

In one embodiment a method of determining a lawn treatment plan and delivering lawn treatments includes receiving at a user interface an address having a lawn. The method further includes determining an initial lawn size for the lawn based on the address. The method further includes receiving confirmation of the initial lawn size. The method further includes calculating a lawn treatment plan based on the initial lawn size. The method further includes providing the lawn treatment plan to a customer. The method further includes providing instruction for providing the lawn treatment plan to a fulfillment center. The method further includes delivering packetized lawn treatments according to the lawn treatment plan on a periodic basis to the customer for treatment of the lawn. In one alternative, the method further includes receiving an order indication after providing the lawn treatment plan to the customer; calculating a revised lawn size based on satellite image analysis; and revising the lawn treatment plan according to the revised lawn size. In another alternative, the method further includes delivering a soil test to the customer for sampling of soil from the lawn; receiving the soil test and the soil at a lab; determining soil composition of the soil; and revising the lawn treatment plan according to the soil composition. Alternatively, the method further includes receiving from the consumer, answers to a questionnaire; and revising the lawn treatment plan according to the answers. In another alternative, the method further includes determining an amount of a required nutrient for a period of time by the lawn; and determining what packets of a plurality of possible packets to deliver to meet the amount, wherein the plurality of possible packets are provided in preset configurations of sizes and nutrient contents. In one alternative, the packets are selected based on the soil composition, current year weather, forecast weather, and the answers to the questionnaire. Alternatively, the soil composition is initially based on location of the address. In another alternative, the growth potential for the lawn is determined for the selection of the packets. Alternatively, the lawn treatment plan is adjusted according to changes in long term weather forecasts. In another alternative, the lawn treatment plan is adjusted according to recent weather trends.

In another embodiment, a method for determining lawn treatments includes receiving at a computing system, a plurality of questionnaire answers, a soil composition report, and an address. The method further includes calculating a grass yard size based on the address with the computing system. The method further includes calculating, with the computing system, a nutrient concentration based on the plurality of questionnaire answers, the soil composition report, and the address. The method further includes determining a lawn treatment pouch contents based on the grass yard size and the nutrient composition. The method further includes scheduling the delivery of the lawn treatment pouch based on the plurality of questionnaire answers, the soil composition report, and the address. The method further includes delivering instructions to a customer for the application of the lawn treatment pouch, the instructions based on the plurality of questionnaire answers, the soil composition report, and the address.

A computer program, stored in a non-transitory computer readable medium, for implementing a method when being executed on a computer or signal processor, the method including receiving at a user interface an address having a lawn. The method further includes determining an initial lawn size for the lawn based on the address. The method further includes receiving confirmation of the initial lawn size. The method further includes calculating a lawn treatment plan based on the initial lawn size. The method further includes providing the lawn treatment plan to a customer. The method further includes providing instruction for providing the lawn treatment plan to a fulfillment center. The method further includes delivering packetized lawn treatments according to the lawn treatment plan on a periodic basis to the customer for treatment of the lawn.

### BRIEF DESCRIPTION OF THE DRAWINGS

FIG. 1 shows one embodiment of a system for creating automatic treatment regimens and delivering lawn treatments;

FIG. 2 shows a flow chart for one embodiment of a method of creating automatic treatment regimens and delivering lawn treatments.

### DETAILED DESCRIPTION

Certain terminology is used herein for convenience only and is not to be taken as a limitation on the embodiments of the systems and methods for lawn nutrient and treatment regimen based on publicly available information and specific testing data and the periodic delivery of supplies for said lawn nutrient and treatment regimen. In many embodiments, an electronic/online system is offered to users whereby they may provide certain information to assist in determining how their lawn needs to be treated. Typically, this information includes answers to a questionnaire, the address of the property, and soil composition information. In many embodiments, the soil composition information may be acquired via the customer requesting to receive a sampling device and subsequently sending a portion of soil to be analyzed. The term “soil composition” may refer to the type of soil in terms of physical properties (such as silt, clay, sand, peat, etc.) and/or the chemical composition of the soil (nitrogen and phosphorus composition, etc.). Alternatively, a sampling device/sample transmission device may be picked up at a local store. In response to the information provided by the user, an automatic treatment regimen is determined (“ATR”) and if the user opts in, nutrients, pesticides, or other treatments (collectively “lawn treatments”) are periodically delivered to the user. In many scenarios, this is done in an automated fashion, via mail or other package handing system. In many scenarios, the Lawn Treatments are delivered in a pouch that is connectable to a hose for application. This may also be referred to as packetized lawn treatments.

In many scenarios, embodiments of the system function to provide a customer with packetized fertilizer that may be delivered on a periodic basis, customized to the customer's lawn. Typically, the starting point for is analysis is web interface/browser, which is implemented to be presented on a variety of devices, including typical personal computers, tablets, and smart phones. A lawn treatment plan engine is used to present the user/customer with certain prompts, determine a treatment plan, and provide instructions, as well as accomplish various tasks. The term “engine” as used herein is not intended to be limiting and may represent may different virtual (software based) and physical structures. A customer is prompted to provide details concerning the location of their lawn. This is accomplished via an interface requesting an address. The location of the property is determined via the address and an estimate of the lawn of the property is determined according to algorithms or publicly available information. (More information on specific techniques is found herein.) Based on the address, characteristics of the lawn are determined. These characteristics may include the climate (temperature, rainfall), the soil content, and the growth potential. These characteristics are determined via algorithms and/or publicly available information. (More information on specific techniques is found herein.) Additionally, in some alternatives, the customer may answer a questionnaire, including information about historical fertilization, health of the lawn, important characteristics of the lawn to the customer, the age of the lawn, the traffic of the lawn (pets, kids), and the lawn care experience of the customer. A lawn plan or ATR is generated for the customer. The ATR includes information describing the periodic shipments that will be made including packetized lawn treatments. The customer is also presented with instructional information, which may be in the form of various media, including but not limited to, written instructions, video, audio. Additionally, the user may be provided an application device for the packetized lawn treatments (sprayer for a hose) as well as a soil test kit. In many alternatives, the ATR is updated according to changing information about climate, lawn size, and soil composition. In many scenarios, after the initial ATR is provided, it is modified according to the soil analysis and a more precise calculation of the lawn size of the property.

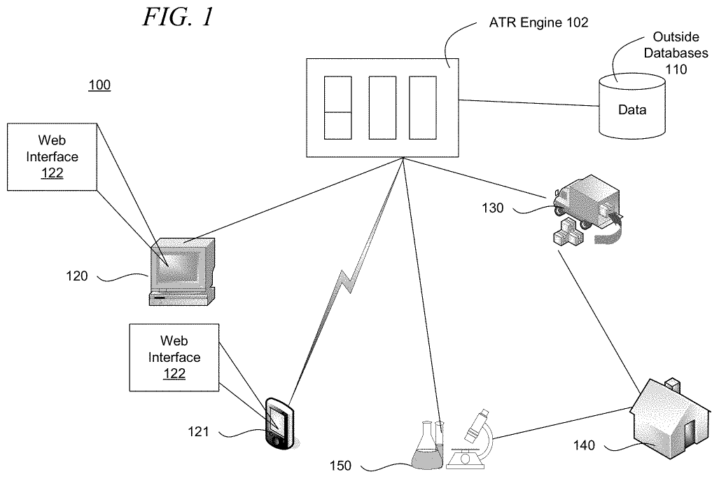

FIG. 1 shows an embodiment of a system 100 that generates an ATR and delivers packetized lawn treatments. The ATR engine 102 interfaces with a customer via a network and computing device 120 or smart phone 121. The customer is presented with a web interface 122, whereby the user may provide their address and the other information discussed herein. This information is provided to the ATR engine 102, which may gather information from 3^{rd} party services or outside databases 110. Based on all of this, ATR creation system 102 creates an ATR that is then presented to the customer (user). If the customer purchases the service, the ATR is further refined, and the plan is sent to the shipping/product center 130. Packetized lawn treatments are delivered to the customer's home 140 along with a soil sample kit. The customer then sends the soil sample to the indicated lab 150. Results from soil testing may then be provided to ATR engine 102, which may further refine the ATR. Additionally, ATR creation system 102 may revise the ATR periodically or responsive to a change in weather conditions or other change.

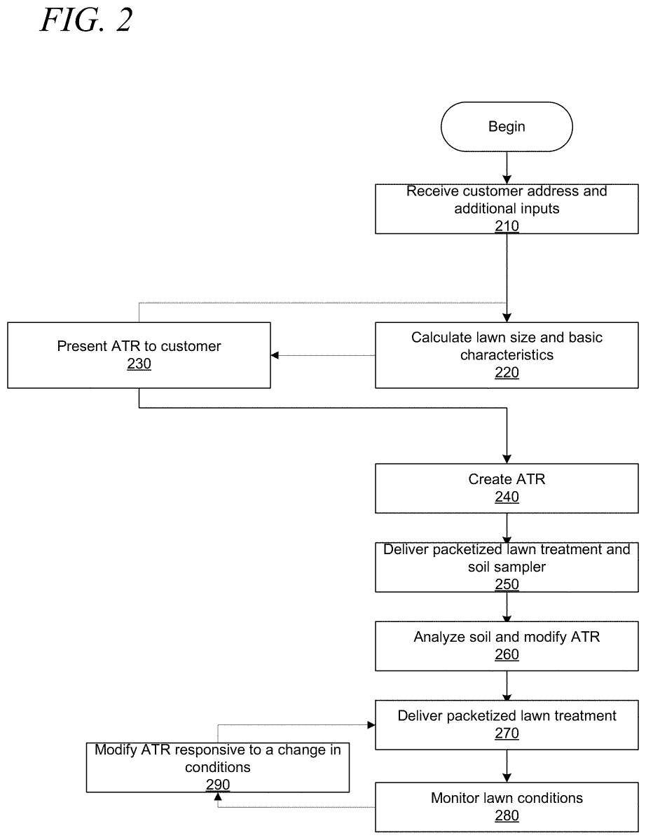

FIG. 2 shows a flow chart for operation of one embodiment of a method of creating an ATR and the provision of lawn treatments to a user. In block 210, a processing system (like ATR engine 102) receives a user address. Additionally, inputs may be receive as well that specify additional characteristics about the lawn. The lawn size characteristics are created in block 220. This lawn size is then presented to the customer in block 230. If the customer approves the lawn size, then the flow continues to block 240. In block 240 the ATR is created. Notice is sent to ship packetized lawn treatment and a soil sampler in block 250. Once the customer samples their soil and send it to a lab, the soil is analyzed in block 260 and the ATR may be modified. Additional packetized lawn treatments are accordingly provided in block 270. Changing weather and other conditions may be continually monitored (or periodically monitored) in block 280. In block 290, the ATR may be modified responsive to changes in expected weather or other changes and modified ATR may be created.

In one embodiment, a method of generating ATRs includes the use of a computing system. A user/consumer that is interested in an ATR provides data input so that a computing system may generate an ATR. Typically, the user provides data inputs that include: the lawn address, the GPS location, images of the lawn/area, answers to a questionnaire (including whether kids will use the lawn, whether pets will use the lawn, the age of the lawn, and the goals for the lawn), the lawn size (via customer mapping tool or via direct customer input). In some embodiments, merely the lawn address is provided, and the ATR is calculated merely on that basis.

When the inputs are received various calculations are performed by the system in order to generate the ATR. The first of these calculations is the determination of lawn size. Typically, this is done on the basis of property data. This may be obtained from a third-party service, such as Zillow or ReportAll, which will typically provide lawn size information. In one embodiment, reports are taken from multiple third-party services and averaged. In one embodiment reports are taken from multiple third-party sources and any outlier values are eliminated and then the results are averaged. Alternatively, direct calculation of the lawn size may be performed. In this alternative, the lot size, home size, and home value may be included in the calculation. In another embodiment, AI/ML/Regression (artificial intelligence, machine learning) prediction may be used. This may rely on computer vision, neutral net or KNN (k nearest neighbor algorithm) or existing user data. In another embodiment, the user may manual map the lawn space on a map provided electronically to the user and the calculation may be based on this map. In one embodiment, the system relies on a hierarchical cross-checked lawn area calculation system, whereby the system relies on the best data possible from the above-mentioned items, which is cross checked for consistency.

In many embodiments, the computing system receives from additional sources. These sources may include sources for property data that may then be converted to lawn size. As previously indicated, this data may be obtained from a third-party source such as Zillow or ReportAll as well as others. It may be a direct calculation of lawn size from property data (lot size, home size, home value, etc.). It may be an AWL/Regression prediction (computer vision, neural net or KNN based on existing user data). Or it may be the result of a Internal manual mapping tool.

As part of the calculation of an ATR, climate information may be important. Climate information, may be obtained by the system by accessing static climate models (USDA, PRISM). It may be modified or created via ᵣₑₐₗₜᵢₘₑ/forecast data from NOAA, USDA, Iteris ClearAG API, etc. Finally, it may result from a network of sensor data from existing users (digital thermometer, rain gauges, soil monitor, etc).

As part of the calculation of an ATR, the composition of soil may be calculated. Sources of this type of data may include estimates from USDA, CONUS-Soil, STATSGO, or SSURGO. Beyond that, the actual pH and composition of the soil may be calculated via realtime data from Iteris ClearAG API, etc., via soil test via sample, or via ML/Regression prediction using company database of existing soil tests.

As part of the calculation of an ATR, customer behavior may be monitored, predicted, or otherwise evaluated. Desirable characteristics for determination may include the demographics of the residents of the dwelling where the lawn is located, whether there are kids, pets, income, and relationship status.

In relation to lawn size, in some embodiments, a system whereby the initial estimate is based on property size data using algorithm based on current library of mapped lawns is used. Subsequently, in many configurations this is shown to the user, so the user can verify the lawn size. Alternatively, the lawn size may be mapped virtually, using satellite imagery and a custom in house mapping tool. In one possible configuration, the user may access a lawn size system via a web browser or similar remote access system. The user may enter their address and the system may automatically calculate a lawn size based on property size data using algorithm based on current library of mapped lawns. This lawn size may be provided to the user and the user may be asked to verify that the size is approximately correct or in the alternative, enter a different lawn size. Subsequently to a user signing up for the service of having packetized fertilizer delivered, the system may present the user with a satellite image of the user's property and a mapping tool for drawing on the map/satellite image, the location of lawn. In alternatives, improved internal algorithm based on KNN or other ML algorithms may be used in the calculation.

As part of the calculation of an ATR, the grass type may be calculated. In order to calculate the grass type, one option is to take the average temperature range of the 3 winter months (November-January) and classify based on range. One possible range is for under 45 F to be the Cool season, 45 F-50 F to be the Transitional season, and for 50 F+ to be the Warm season.

Additional innovations in some embodiments include, expert created/maintained maps, prediction based on existing customer data. computer vision analysis (i.e. PlantSnap, which is a third party API allowing for the identification of weeds and grasses), and direct customer input. In many embodiments, the customer may provide data concerning their lawn including images of the lawn and answers to questions. By using this data in conjunction with expert maps of typical grass types, a prediction concerning grass type for the customer may be made.

Typically, as part of the calculation of an ATR, the growth potential for a lawn is calculated. This is based on grass type (Cool/Transitional vs. Warm) use historical average daily temperatures to create annual growth potential curve. In terms of grass type, transitional means that both cool and warm grasses can survive in the region. In many embodiments, the system defaults to use cool season grass metrics in transitional zones because it is safer. Treating cool season like warm season will lead to nitrogen burn, but treating warm season like cool season is fairly safe. In many embodiments, the names of the grass types including cool, transitional, and warm are not technical terms, but characterizations made for the purpose of determining the proper treatment regime. One equation that may be used for identification of grass type includes (equation 1):

$$100 \times {e}^{( - \frac{1}{2} {( \frac{average temperature - optimum growth temperature}{variance} )}^{2} )}$$

Additionally, cloud cover, shade, and hours of sunlight based on season may be used as part of a calculation for ATR.

Typically, as part of the calculation of an ATR, Growing Degree Days may be calculated using standard GDD calculation for grass type based on historical climate data. Three different methods are used to calculate degree days; i.e., 1) Averaging Method; 2) Baskerville-Emin (BE) Method; and 3) Electronic Real-time Data Collection. All methods attempt to calculate the heat accumulation above a minimum threshold temperature, often referred to the base temperature. Once both the daily maximum and minimum temperatures get above the minimum threshold temperature, (i.e., base temperature of 42 degrees, 50 degrees or whatever other base temperature of interest) then all methods are fairly comparable.

In more detail, the methods are: 1. Averaging Method: Easy to calculate Degree Days(DD)=Average daily temp.−Base Temp.=(max.+min.)/2−Base temp; 2. BE Method: Fits a curve (more specifically a sine curve) to the maximum and minimum temperature to simulate how the temperature varies, then calculates the area of the curve above the base temperature using calculus; and 3. Electronic Weather Data Collection devices don't need to go through these arithmetic calculations. Instead, these devices record temperatures every few minutes.

In some embodiments, additional methods may be used to calculate growing degree days including calculating/obtaining real time GDD information using current year temperature data from Iteris ClearAG API or other service.

Typically, part of the calculation of an ATR includes a calculation of grass stress level. In many configurations, stress zones occur between 2 peaks in the growth curve as the average temp exceeds the optimum GP temp. As GP drops due to elevated temperature, nitrogen limits per application are reduced. Therefore, the nitrogen needed may be calculated. Normal nitrogen needed is 0.4 lbs/1 k sqft and under heat Stress: Normal×% GP off peak×Scale Factor. In alternatives, calculation using both temperature and humidity on an hourly sample rate may be used as well. In some alternatives, the sum of tempT and humidity % greater than 150 may be taken into account. Additionally, when the number of nightime hours temp 69 F over.

Typically, as part of the calculation of an ATR, turf risk factors are modeled. One turf risk factor is the risk of pests. Pests may include mold, fungus, weeds, and insects. Additional factors may include drought and heat stress.

In one embodiment, the creation of an ATR or Lawn Plan involves numerous steps. The objective is to optimize nutrient type, rates, and timing based on calculated lawn needs with final output being physical products with specific application dates to be applied by the user. In order to achieve this, nutrients are calculated, growth potential is calculated, heat stress is calculated, risk factors are calculated, and these calculations are applied to a pouch selection. In other words, part of the calculation is properly fitting the standard available pouches in order to meet the demands of the lawn but not exceed single application limits, especially in a manner that would damage the lawn in question. For nutrient calculation, an important nutrient is nitrogen. In this case the targets include a seasonal total application rate (1.25 lbs/1 k sqft/year). At the same time, there is an Application limit 0.4 lbs/1 k sqft. Additionally, Macronutrients such as Phosphorus & Potassium are important. As previously identified, the optimization of meeting nutrient targets while not exceeding single application limits while addressing risk factors within the confines of a limited selection of SKUs is desirable.

In many alternatives, the plan and the data for each lawn is optimized over time. In summary, new data points may trigger updates in the plan to address newly discovered issues. Soil test results may show a deficiency in a certain nutrient and in response the plan (ATR) is then updated with a pouch to address the deficiency. In some situations, a customer may have a very warm winter, which in turn triggers an update in application dates to accelerate applications earlier in the season. Also, plan tracking may show that customer is behind on applications and therefore trigger a plan update to reduce number of applications for remainder of the season. Additionally, the customer may submit images of their lawn showing obvious pest problem, which in turn triggering update of pouch/product specifically targeted at addressing issue.

In order to execute a ATR, a number of steps are taken. Custom application dates for all products to create plan made of physical skus are generated. Selected skus are bundled into shipments to optimize for customer experience while minimizing shipping costs. Delivery dates are generated as well as timelines. These date sequences are transmitted to the shipping warehouse such that the orders may be fulfilled. Finally, custom instructions and direct to user guidance on how to execute lawn plan and track progress and results are generated and delivered to the consumer.

Additionally, in many embodiments, the system may include learning processes whereby the system learns from the history of applications and results for a single lawn over time and learns from the entire dataset of all lawns at the same snapshot in time so that every lawn benefits the knowledge gained from other lawns.

In one embodiment of a lawn size calculation technique, the calculation starts with the user's entry of an address. This is typically accomplished via a web/browser interface. This may be accomplished via a text box with autocomplete provided by Google address API. In many embodiments the address may later be validated. This process returns a validated address along with GPS location. Based on this the system may then pull property data and calculate initial_lawn_size. Property lot data may be retrieved via various 3rd party APIs.

From there, the initial size calculation can occur. This may be achieved using lot_size as the only parameter, estimate lawn size using a polynomial fit based on internal data validated from mapping of 30 k+ lawns. This is based on the equation, initial_lawn_size=A₄l⁴+A₃l³+A₂l²+A₁l+A₀ where l is the lot_size of the property in sqft. This simple calculation is extremely fast and allows system to quickly begin building custom lawn plan. In some alternatives, more advanced system is used which uses lot_size, latitude and longitude as input parameters to train a gradient boosted decision tree using mapping data of 30 k+ lawns. In many embodiments, the open-source XGBoost software library for implementing such a functionality. This calculation may improve lawn size estimates with the GPS data already available from the address autocomplete.

In many cases, the initial_lawn_size data is provided to user for confirmation/update. The user may receive a series of prompts allowing the user to view the estimated lawn size and do one of the following: Confirm lawn size and continue; Update lawn size with user supplied value; Request manual review by mapping team. Subsequently, in some alternatives, an internal team then confirms the lawn size. Subsequently, the system creates a lawn place of ATR using this lawn size.

Subsequently, the lawn size may be automatically reviewed based on satellite imagery is pulled for the property from 3rd party API (Google, NearMap, etc) and using a custom mapping tool, the lawn area may be manually mapped to increase the accuracy. In one alternative, the manual mapper is shown a series of satellite images from different times of year, which then may be drawn onto using a polygon drawing tool to draw overlay on all lawn areas. The system then automatically calculates the lawn area using the polygons geometry. Subsequently the lawn size may be updated to be an observed lawn size or observed_lawn_size. This may modify the ATR for the lawn address identified. This the ATR is based on packetizing lawn treatment, various changes will occur based on this an possibly including modifying the number of fertilizer pouches decreased due to smaller total Nitrogen requirement; the number of fertilizer pouches unchanged due to no change in total Nitrogen requirement; the number of fertilizer pouches increased due to higher total Nitrogen requirement; or complete modification of the plan based on the original plan being too far off to be modifiable.

Based on the lawn size plan, an ATR is then calculated. Various pieces of data are then provided. The lawn size in many embodiments is provided via the above identified methods. Lawn-weather-data service may be provided based on the location of the property. Climate data is retrieved from an internal lawn-weather-data service which is comprised of 4 static data sets which can be looked up based on any pair of GPS coordinates in the continental US. The datasets included are listed below:

30 year average temperature;

30 year average rainfall;

30 year average growth potential (see below for basic method of calculation); and

continental soil type.

Additionally, in some embodiments the lawn-weather-data service may provide 10 and 15 year averages of the same above items as well as the likely grass type in an area.

Additionally, the historical climate data is determined. This is based on 30-year average temperature & rainfall values are determined from public & private data sources (NOAA, PRISM, etc.).

Additionally, growth potential data is calculated. This is done in part on the calculation of 30-year growth potential is calculated and compiled to a single static dataset using the steps below. First, the system determines the average monthly temp for the 3 cold season months November, December, & January using 30-year average temperature. The system then uses the following checks to approximate the grass type: If the average temp is below 40 F, classify as COOL season grass; If the average temp is below 45 F, classify as TRANSITIONAL season grass; If the average temp is below 40 F, classify as WARM season grass

Once grass type is known, the growth potential can be calculated using the equation 1 above. Optimum growth temp & variance is determined by the grass type: COOL & TRANSITIONAL->67.5 F, 10; WARM->87.5 F, 12. These growth potentials are calculated and compiled into a single static data set for fast lookup via GPS coordinates.

Finally, the continental soil type is determined. In one configuration, static date from various publicly available databases is aggregated, including CONUS-SOIL, STASGO, SSURGO. This data is then compiled into a single binary for rapid lookup.

In one embodiment, the initial plan creation for an ATR includes a number of steps. First, the system calculates season start & season end dates from the growth potential curve (% GP vs. day of the year): The GP curve varies from 0-100, with 100 being max growth potential. The season start is determined when the GP goes above a specified value: (COOL->30, WARM->20). Season end is determined when the GP drops below a specified value: (COOL->20, WARM->20). Then the heat stress dates are calculated: heat stress occurs in COOL season grasses when the average daily temperature is above the optimum growing temperature during heat stress, grass is extremely stressed.

Subsequently, the system calculates Nitrogen targets and limits based on the lawn size: Annual nitrogen target: ->for optimum grass growth; Max nitrogen per application: ->to prevent nitrogen burn. Note: Max nitrogen per application is reduced during heat stress linearly based on the following: max N per app is reduced 0.1 lbs for every drop on 10% points in GP, i.e. 70% GP->30-point drop=0.3 lbs N drop->.

Thereafter, the application dates may be calculated. The number of applications vary from 1-6. In some configurations, the initial fertilizer application dates are calculated based on 2 criteria: minimum spacing between applications is 2 weeks; evenly spread applications dates across remaining season. This is adjusted according to when customers start using the packet delivery system. Based on criteria above, calculate all possible application dates for 1-6 applications. Note: For late season signups, it will often only be possible to get 1-2 applications despite a standard plan being a minimum of 3. The end results will be a set of 1-6 sets, with each set containing a total number of applications and their respective dates.

Once the number of applications is set, the selection of pouches may occur. The selection of pouches is an iterative process that occurs continuously throughout the season as new data is ingested by the “lawn engine”. Example data includes but is not limited to the following:
soil test results (deficiencies in potassium, phosphorus, etc.)
current year weather (abnormally wet/dry, warm/cold, etc)
forecast weather (expected rainfall can affect application dates to maximize plant absorption)
user inputs (pest issues, delay shipments, etc.).

Initial pouch selection is governed primarily by an effort to hit nitrogen target while never exceeding max nitrogen per applications. When possible, the goal is to minimize the number of applications while staying within the N guidelines outlined above. With this in mind, the iterative pouch selection process begins with the application date set with the fewest number of applications.

Per Application Pouch Selection:
1. Eliminate any pouches with N exceeding the max N per app criteria. Note: This is done in a per application basis, so pouches available during start and end of season will differ from heat stress zone
2. Select pouches based on weighted optimization criteria taking into account the needs of the lawn and values associated with each pouch. At the most basic level the only criteria is nitrogen, but in more advanced setup it includes other factors including but not limited to potassium, phosphorus, micronutrients, pest/weed risk, seasonality, weather (drought, freeze, etc). Weighted optimization scale ranges from −100 to 100, 100 being the greatest need for the lawn (100=max affinity), −100 being the greatest aversion for the lawn (−100=max aversion), 0 being no effect on the lawn (good or bad).

### Example: First Application of the Year

Date: 2020-04015

Lawn Needs: scale ranges from −100 to 100

Nitrogen=100

Spring Season=100

Winter Season=0

Pouch Options:

Iron Booster Pouch:

Nitrogen: 70

Spring: 100

Winter: 0

Winter Prep Pouch:

Nitrogen: 80

Spring: 0

Winter: 100

Weighted Optimization Calculation:

Iron Booster:

Nitrogen=70*100=700

Spring=100*100=1000

Winter=0*0=0

Total Weight=1700

Winter Prep Pouch:

Nitrogen=80*100=800

Spring=0*100=0

Winter=100*0=0

Total Weight=800

Iron Booster pouch is selected because of higher weighted score (1700>800). While Winter Prep has a higher Nitrogen boost for the application, the seasonal weight for the spring preference dominates the weighting and selects Iron Booster

In many embodiments, it is necessary to match pouches to the needed applications. The Per Application Pouch Selection process is repeated for all applications for each application set. Once all possible plans are created, each plan will already meet the maximum N per app criteria. The plans are then ranked based on the following criteria:
Eliminate all plans which do not meet the total annual N target
Sort the remaining plans by total number of applications from lowest to highest
Select the plan with the lowest number of applications.

Additionally, in some embodiments the behavior of the customer is tracked. The customer may be periodically prompted by the ATR engine to provide the date at which the packetized lawn treatment was applied. This may occur via email, text, or other contact method. Additionally, the customer may request the delay of a packetized lawn treatment shipment, and the ATR engine may thereby assume a delay in application of packetized lawn treatments and may estimate this delay or contact/prompt the customer for more information. In response to a delay, the ATR engine may adjust the amounts, timing, and make up of packetized lawn treatments, in order to optimize treatment and prevent overtreatment.

In many embodiments, parts of the system are provided in devices including microprocessors. Various embodiments of the systems and methods described herein may be implemented fully or partially in software and/or firmware. This software and/or firmware may take the form of instructions contained in or on a non-transitory computer-readable storage medium. Those instructions then may be read and executed by one or more processors to enable performance of the operations described herein. The instructions may be in any suitable form such as, but not limited to, source code, compiled code, interpreted code, executable code, static code, dynamic code, and the like. Such a computer-readable medium may include any tangible non-transitory medium for storing information in a form readable by one or more computers such as, but not limited to, read only memory (ROM); random access memory (RAM); magnetic disk storage media; optical storage media; a flash memory, etc.

Generally, embodiments of the systems and methods described herein may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the method is, therefore, a computer program having a program code for performing one of the methods described herein, when the computer program runs on a computer.

Embodiments of the systems and methods described herein may be implemented in a variety of systems including, but not limited to, smartphones, tablets, laptops, and combinations of computing devices and cloud computing resources. For instance, portions of the operations may occur in one device, and other operations may occur at a remote location, such as a remote server or servers. For instance, the collection of the data may occur at a smartphone, and the data analysis may occur at a server or in a cloud computing resource. Any single computing device or combination of computing devices may execute the methods described.

In various instances, parts of the method may be implemented in modules, subroutines, or other computing structures. In many embodiments, the method and software embodying the method may be recorded on a fixed tangible medium.

While specific embodiments have been described in detail in the foregoing detailed description, it will be appreciated by those skilled in the art that various modifications and alternatives to those details could be developed in light of the overall teachings of the disclosure and the broad inventive concepts thereof. It is understood, therefore, that the scope of this disclosure is not limited to the particular examples and implementations disclosed herein but is intended to cover modifications within the spirit and scope thereof as defined by the appended claims and any and all equivalents thereof.

What is claimed as new and desired to be protected by Letters Patent of the United States is:

1. A system for determining a lawn treatment plan and delivering lawn treatments, the system comprising:
a lawn treatment plan engine, the lawn treatment plan engine configured to query a customer for an address having a lawn;
receive the address;
calculate an initial lawn size for the lawn based on the address;
receive a confirmation of the initial lawn size;
calculate a lawn treatment plan based on the initial lawn size;
provide the lawn treatment plan to a customer; and
provide instruction for providing the lawn treatment plan to a fulfillment center for delivering packetized lawn treatments according to the lawn treatment plan on a periodic basis to the customer for treatment of the lawn.

2. The system of claim 1, wherein the lawn treatment plan engine is further configured to receive an order indication after providing the lawn treatment plan to the customer;
calculate a revised lawn size based on satellite image analysis; and
revise the lawn treatment plan according to the revised lawn size.

3. The system of claim 2, wherein the lawn treatment plan engine is further configured to cause a fulfillment center to deliver a soil test to the customer for sampling of soil from the lawn;
receive soil composition based on the customer delivering the soil test to a lab and the lab determining the soil composition; and
revise the lawn treatment plan according to the soil composition.

4. The system of claim 3, wherein the lawn treatment plan engine is further configured to receive from the consumer, answers to a questionnaire; and
revise the lawn treatment plan according to the answers.

5. The system of claim 4, wherein the lawn treatment plan engine is further configured to as part of the determination of the lawn treatment plan to determine an amount of a required nutrient for a period of time by the lawn;
determine what packets of a plurality of possible packets to deliver to meet the amount, wherein the plurality of possible packets are provided in preset configurations of sizes and nutrient contents.

6. The system of claim 5, wherein the packets are selected based on the soil composition, current year weather, forecast weather, and the answers to the questionnaire.

7. The system of claim 6, wherein the soil composition is initially based on location of the address.

8. The system of claim 7, wherein the growth potential for the lawn is determined for the selection of the packets.

9. The system of claim 8, wherein the lawn treatment plan is adjusted according to changes in long term weather forecasts.

10. The system of claim 8, wherein the lawn treatment plan is adjusted according to recent weather trends.

11. The system of claim 1, wherein the lawn treatment plan is adjusted according to a change in known characteristics of the lawn.

12. The system of claim 1, wherein the lawn treatment plan is adjusted according to a change in characteristics of the lawn.

13. The system of claim 1, wherein the lawn treatment plan is adjusted according to a change in environmental characteristics of the lawn.

14. The system of claim 1, wherein the lawn treatment plan is adjusted according to the customer compliance with the lawn treatment plan.

15. A method of determining a lawn treatment plan and delivering lawn treatments, the method comprising:
receiving at a user interface an address having a lawn;
determining an initial lawn size for the lawn based on the address;
receiving confirmation of the initial lawn size;
calculating a lawn treatment plan based on the initial lawn size;
providing the lawn treatment plan to a customer;
providing instruction for providing the lawn treatment plan to a fulfillment center; and
delivering packetized lawn treatments according to the lawn treatment plan on a periodic basis to the customer for treatment of the lawn.

16. The method of claim 15, further comprising:
receiving an order indication after providing the lawn treatment plan to the customer;
calculating a revised lawn size based on satellite image analysis; and
revising the lawn treatment plan according to the revised lawn size.

17. The method of claim 15, further comprising:
delivering a soil test to the customer for sampling of soil from the lawn;
receiving the soil test and the soil at a lab;
determining soil composition of the soil; and
revising the lawn treatment plan according to the soil composition.

18. The method of claim 17, further comprising;
receiving from the consumer, answers to a questionnaire; and
revising the lawn treatment plan according to the answers.

19. The method of claim 18, wherein as part of the determination of the lawn treatment plan, determining an amount of a required nutrient for a period of time by the lawn; and
determining what packets of a plurality of possible packets to deliver to meet the amount, wherein the plurality of possible packets is provided in preset configurations of sizes and nutrient contents.

20. The method of claim 19, wherein the packets are selected based on the soil composition, current year weather, forecast weather, and the answers to the questionnaire.

21. The method of claim 20, wherein the soil composition is initially based on location of the address.

22. The method of claim 21, wherein the growth potential for the lawn is determined for the selection of the packets.

23. The method of claim 22, wherein the lawn treatment plan is adjusted according to changes in long term weather forecasts.

24. The method of claim 22, wherein the lawn treatment plan is adjusted according to recent weather trends.

25. A method for determining lawn treatments, the method comprising:
receiving at a computing system, a plurality of questionnaire answers, a soil composition report, and an address;
calculating a grass yard size based on the address with the computing system;
calculating, with the computing system, a nutrient concentration based on the plurality of questionnaire answers, the soil composition report, and the address;
determining a lawn treatment pouch contents based on the grass yard size and the nutrient composition;
scheduling the delivery of the lawn treatment pouch based on the plurality of questionnaire answers, the soil composition report, and the address; and
delivering instructions to a customer for the application of the lawn treatment pouch, the instructions based on the plurality of questionnaire answers, the soil composition report, and the address.

26. A computer program, stored in a non-transitory computer readable medium, for implementing a method when being executed on a computer or signal processor, the method comprising:
receiving at a user interface an address having a lawn;
determining an initial lawn size for the lawn based on the address;
receiving confirmation of the initial lawn size;
calculating a lawn treatment plan based on the initial lawn size;
providing the lawn treatment plan to a customer;
providing instruction for providing the lawn treatment plan to a fulfillment center; and
delivering packetized lawn treatments according to the lawn treatment plan on a periodic basis to the customer for treatment of the lawn.
